(19) United States
(12) Patent Application Publication
(10) Pub. No.: US 2011/0235494 A1
(43) Pub. Date: Sep. 29, 2011

(54) Optical Pickup Apparatus

(75) Inventors: Tohru Hotta, Okaya-shi (JP); Ryoichi Kawasaki, Isesaki-shi (JP)

(73) Assignees: Sanyo Electric Co., Ltd., Osaka (JP); Sanyo Optec Design Co., Ltd., Tokyo (JP)

(21) Appl. No.: 12/890,301

(22) Filed: Sep. 24, 2010

(30) Foreign Application Priority Data
Sep. 28, 2009 (JP) 2009-222163
Sep. 28, 2009 (JP) 2009-222177
Sep. 28, 2009 (JP) 2009-222181

(51) Int. Cl. G11B 7/135

(52) U.S. Cl. 369/112.02; 369/112.05; G9B/7.113

(57) ABSTRACT

An optical pickup apparatus includes: a laser diode configured to generate a laser beam; and an objective lens having an annular diffraction zone formed on an incident surface thereof on which the laser beam is incident, the annular diffraction zone being a zone configured to focus the laser beam on each of signal recording layers of first to third optical discs so that a signal recorded in each of the signal recording layers of the first to third optical discs are read, the first optical disc having the signal recording layer at a first distance from a surface thereof, the second optical disc having the signal recording layer at a second distance longer than the first distance from a surface thereof, the third optical disc having the signal recording layer at a third distance longer than the first distance and shorter than the second distance from a surface thereof.

### CROSS-REFERENCE TO RELATED APPLICATIONS

This application claims the benefit of priority to Japanese Patent Application Nos. 2009-222163, Nos. 2009-222177, and 2009-222181, all filed Sep. 28, 2009, of which full contents are incorporated herein by reference.

### BACKGROUND OF THE INVENTION

1. Field of the Invention

The present invention relates to an optical pickup apparatus to perform an operation of reading signals recorded in an optical disc and an operation of recording signals into the optical disc.

2. Description of the Related Art

An optical disc apparatus is known that is capable of performing an operation of reproducing signals and an operation of recording signals with a laser beam, which is emitted from a pickup apparatus, being applied to a signal recording layer of an optical disc.

Although an optical disc apparatus of a type using an optical disc called a CD or a DVD is generally known, an apparatus of a type using an optical disc with an improved recording density, i.e., a Blu-ray standard optical disc, is recently developed.

An infrared beam having a wavelength of 785 nm is used as the laser beam for performing an operation of reading signals recorded in a CD standard optical disc, while a red beam having a wavelength of 655 nm is used as the laser beam for performing an operation of reading signals recorded in a DVD standard optical disc.

A transparent protection layer provided between a signal recording layer included in the CD standard optical disc and the surface thereof has a thickness of 1.2 mm, and the numerical aperture of an objective lens to be used for performing the operation of reading signals from the signal recording layer is set at 0.47. A transparent protection layer provided between a signal recording layer included in the DVD standard optical disc and the surface thereof has a thickness of 0.6 mm, and the numerical aperture of an objective lens to be used for performing the operation of reading signals from the signal recording layer is set at 0.6.

As compared with cases of the CD standard and DVD standard optical discs, the laser beam having a shorter wavelength, e.g., a blue-violet beam having a wavelength of 405 nm, is used as the laser beam for performing an operation of reading signals recorded in a Blu-ray standard optical disc.

A transparent protection layer provided on an upper surface of a signal recording layer included in the Blu-ray standard optical disc has a thickness of 0.1 mm, and the numerical aperture of an objective lens to be used for performing the operation of reading signals from the signal recording layer is set at 0.85.

It is required to reduce the diameter of a laser spot generated by focusing the laser beam for reproducing signals recorded on the signal recording layer included in the Blu-ray standard optical disc and for recording signals onto the signal recording layer. The objective lens to be used for obtaining a desired laser spot shape is characterized by that a radius of curvature thereof is reduced since not only that a numerical aperture thereof is increased but also that a focal length thereof is reduced.

Although such an optical disc apparatus is commercialized that is capable of performing an operation of reading signals recorded in all of the optical discs of the CD standard, DVD standard, and the Blu-ray standard and an operation of recording signals thereinto, an optical pickup apparatus incorporated into such an optical disc apparatus includes a laser diode that emits laser beams having wavelengths corresponding to the above described standards and an objective lens that focuses laser beams emitted from the laser diode onto signal recording layers included in the optical discs.

The optical pickup apparatus capable of performing the operation of reading signals recorded in the optical discs of all the different standards includes two objective lenses, one for performing an operation of focusing the laser beam to be applied to the optical disc of the CD standard and the DVD standard, and the other for performing an operation of focusing the laser beam to be applied to the optical disc of the Blu-ray standard.

The optical pickup apparatus including such two objective lenses has not only a problem that a configuration of an optical system becomes complicated but also a problem that the optical pickup apparatus becomes increased in size. As a method for solving such problems, an art has been developed that allows a single objective lens to focus laser beams onto the optical discs of all the standards.

The optical pickup apparatus involves such a problem that normal signal reproducing or recording operations cannot be performed due to occurrence of a spherical aberration caused by the thickness of the protection layer provided between a disc surface that is a laser-beam-incident surface of the optical disc and the signal recording layer thereof. As a method for solving such a problem, such an art is developed that the spherical aberration is corrected by displacing a collimating lens disposed between the laser diode and the objective lens in the optical axis direction (see, e.g., Japanese Laid-Open Patent Publication Nos. 2006-236414 and 2004-14042).

The optical pickup apparatus described in Japanese Laid-Open Patent Publication No. 2006-236414 is configured such that the operations of reading signals recorded in the optical discs of three different standards are performed using a single objective lens. However, the laser diodes, that respectively emit laser beams having wavelengths respectively corresponding to the standards of the optical discs, is used, and thus, there are not only a problem that the price become increased but also a problem that assembling work cannot be easily performed due to complexity of the optical system as well as the need for individual adjustment for each of the laser beams.

### SUMMARY OF THE INVENTION

An optical pickup apparatus according to an aspect of the present invention, includes: a laser diode configured to generate a laser beam; and an objective lens having an annular diffraction zone formed on an incident surface thereof on which the laser beam is incident, the annular diffraction zone being a zone configured to focus the laser beam on each of signal recording layers of first to third optical discs so that a signal recorded in each of the signal recording layers of the first to third optical discs are read, the first optical disc having the signal recording layer at a first distance from a surface thereof, the second optical disc having the signal recording layer at a second distance longer than the first distance from a surface thereof, the third optical disc having the signal recording layer at a third distance longer than the first distance and shorter than the second distance from a surface thereof.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a schematic diagram of an optical pickup apparatus according to a first embodiment of the present invention;

FIG. 2 depicts a relationship between a first optical disc and an objective lens included in an optical pickup apparatus according to first and second embodiments of the present invention;

FIG. 3 depicts a relationship between a second optical disc and an objective lens included in an optical pickup apparatus according to first and second embodiments of the present invention;

FIG. 4 depicts a relationship between a third optical disc and an objective lens included in an optical pickup apparatus according to first and second embodiments of the present invention;

FIG. 5 depicts a relationship between a blaze height of an annular diffraction zone and diffraction efficiency of a diffracted beam in first and second embodiments of the present invention;

FIG. 6 is a schematic diagram of an optical pickup apparatus according to a second embodiment of the present invention;

FIG. 7 is a schematic diagram of an optical pickup apparatus according to a third embodiment of the present invention;

FIG. 8 depicts a relationship between an optical disc and an objective lens included in an optical pickup apparatus according to third and fourth embodiments of the present invention;

FIG. 9 depicts a relationship between an optical disc and an objective lens included in an optical pickup apparatus according to third and fourth embodiments of the present invention;

FIG. 10 depicts a relationship between an optical disc and an objective lens included in an optical pickup apparatus according to third and fourth embodiments of the present invention;

FIG. 11 depicts a relationship between a blaze height of an annular diffraction zone and diffraction efficiency of a diffracted beam in third and fourth embodiments of the present invention;

FIG. 12 is a schematic diagram of an optical pickup apparatus according to a forth embodiment of the present invention;

FIG. 13 is a schematic diagram of an optical pickup apparatus according to a fifth embodiment of the present invention;

FIG. 14 depicts a relationship between an optical disc and an objective lens included in an optical pickup apparatus according to fifth and sixth embodiments of the present invention;

FIG. 15 depicts a relationship between an optical disc and an objective lens included in an optical pickup apparatus according to fifth and sixth embodiments of the present invention;

FIG. 16 depicts a relationship between an optical disc and an objective lens included in an optical pickup apparatus according to fifth and sixth embodiments of the present invention;

FIG. 17 depicts a relationship between a blaze height of an annular diffraction zone and diffraction efficiency of a diffracted beam in fifth and sixth embodiments of the present invention; and

FIG. 18 is a schematic diagram of an optical pickup apparatus according to a sixth embodiment of the present invention.

### DETAILED DESCRIPTION OF THE INVENTION

At least the following details will become apparent from descriptions of this specification and of the accompanying drawings.

A first embodiment of the present invention will hereinafter be described.

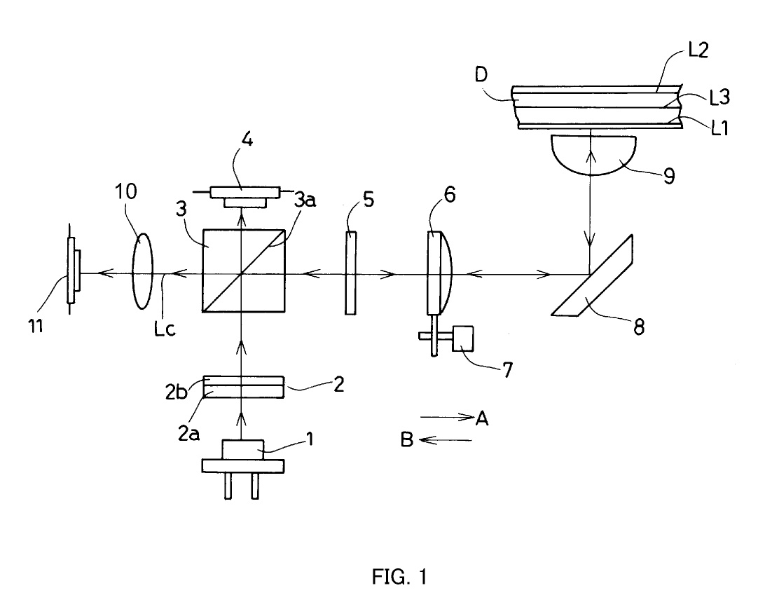

Referring to FIG. 1, reference numeral 1 denotes a laser diode that emits a laser beam which is a blue-violet beam having a wavelength of 405 nm, for example, and reference numeral 2 denotes a diffraction grating on which the laser beam emitted from the laser diode 1 is incident. The diffraction grating 2 includes a diffraction grating unit 2a that splits the laser beam into a main beam, which is a zero-order beam, and into two sub-beams, which are a plus-first-order beam and a minus-first-order beam, and a half-wave plate 2b that converts the incident laser beam into a linearly polarized light beam in an S-direction.

Reference numeral 3 denotes a polarizing beam splitter provided in a position where the laser beam having passed through the diffraction grating 2 is incident. The polarizing beam splitter 3 includes a control film 3a that reflects most of the laser beam, polarized in the S-direction by the half-wave plate 2b, and that allows all of the laser beam, polarized in a P-direction, to pass therethrough. Reference numeral 4 denotes a monitor photodetector provided in a position where the laser beam is incident, which has passed through the control film 3a of the polarizing beam splitter 3 in the laser beam emitted from the laser diode 1. A detection output of the monitor photodetector 4 is used to control the output of the laser beam emitted from the laser diode 1. Reference numeral 5 denotes a quarter-wave plate provided in a position where the laser beam reflected from the control film 3a of the polarizing beam splitter 3 is incident. The quarter-wave plate 5 serves a function of converting an incident laser beam from a linearly polarized light beam into a circularly polarized light beam, or from a circularly polarized light beam into a linearly polarized light beam. Reference numeral 6 denotes a collimating lens on which the laser beam having passed through the quarter-wave plate 5 is incident and which converts the incident laser beam into a parallel beam. The collimating lens 6 is configured so as to be displaced by an aberration correcting motor 7 in an optical axis direction, i.e., in directions indicated by arrows A and B. The configuration is made such that a spherical aberration caused due to the thickness of a protection layer of an optical disc D is corrected by a displacement operation of the collimating lens 6 in the optical axis direction.

Reference numeral 8 denotes a raising mirror (reflection mirror) provided in a position where the laser beam having passed through the collimating lens 6 is incident. The raising mirror 8 is configured to reflect the incident laser beam in a direction of an objective lens 9.

D denotes an optical disc. L1 denotes a signal recording layer included in a first optical disc D1 having a shorter distance (first distance) from the surface of the optical disc to the signal recording layer; L2 denotes a signal recording layer included in a second optical disc D2 having a longer distance (second distance) from the surface of the optical disc to the signal recording layer; and L3 denotes a signal recording layer included in a third optical disc D3 having a distance (third distance) from the surface of the optical disc to the signal recording layer which is longer than that in the first optical disc D1 and shorter than that in the second optical disc D2.

In such a configuration, the laser beam emitted from the laser diode 1 is incident on the objective lens 9 via the diffraction grating 2, the polarizing beam splitter 3, the quarter-wave plate 5, the collimating lens 6, and the raising mirror 8, and thereafter, the laser beam is applied as a focused spot to the signal recording layer L1, L2, or L3 included in the optical disc D by the focusing operation of the objective lens 9. The laser beam applied to the signal recording layer L1, L2, or L3 is reflected as a return beam by the signal recording layer L1, L2, or L3.

The return beam reflected from the signal recording layer L1, L2, or L3 of the optical disc D is incident on the control film 3a of the polarizing beam splitter 3 via the objective lens 9, the raising mirror 8, the collimating lens 6, and the quarter-wave plate 5. The return beam thus incident on the control film 3a of the polarizing beam splitter 3 is converted into a linearly polarized light beam in the P-direction by the phase shift operation of the quarter-wave plate 5. Accordingly, such a return beam is allowed to pass through the control film 3a as a control laser beam Lc without being reflected by the control film 3a.

Reference numeral 10 denotes a sensor lens on which the control laser beam Lc having passed through the control film 3a of the polarizing beam splitter 3 is incident. The sensor lens 10 serves a function of applying the control laser beam Lc, with astigmatism added thereto, to a light receiving portion provided in the photodetector 11 which is called PDIC. The photodetector 11 is provided with a known quad sensor, etc., and is configured to perform, by a main beam application operation, a signal generating operation associated with an operation of reading signals recorded on the signal recording layer of the optical disc D and a focus error signal generating operation for executing a focusing control operation by an astigmatism method, and to perform, by two-sub-beam applying operations, a tracking error signal generating operation for executing a tracking control operation.

The optical pickup apparatus according to an embodiment of the present invention is configured as described above. In such a configuration, the objective lens 9 is fixed to a lens holding frame (not shown) that is supported on a base of the optical pickup apparatus by four or six supporting wires in such a manner as to be capable of a displacement operation in a direction perpendicular to a signal surface of the optical disc D, i.e., in a focusing direction and a displacement operation in a radial direction of the optical disc D, i.e., in a tracking direction.

The above described displacement operations of the objective lens 9 in the focusing direction and the tracking direction are carried out by supplying a drive signal to a focusing coil and a tracking coil provided on the lens holding frame.

The optical pickup apparatus according to an embodiment of the present invention is configured as described above, and an operation of the optical pickup apparatus with such a configuration will be described.

When performing an operation of reproducing signals recorded in the optical disc D, a drive current is supplied to the laser diode 1 and the laser diode 1 emits a laser beam having a wavelength of 405 nm. The laser beam emitted from the laser diode 1 enters the diffraction grating 2, to be split by the diffraction grating unit 2a making up the diffraction grating 2 into a zero-order beam, a plus-first-order beam, and a minus-first-order beam, and to be converted by the half-wave plate 2b into a linearly polarized light beam in the S-direction. The laser beam having passed through the diffraction grating 2 enters the polarizing beam splitter 3, and is reflected by the control film 3a included in the polarizing beam splitter 3, while a portion of the laser beam having passed through the control film 3a is applied to the monitor photodetector 4.

Since the intensity of the laser beam applied to the monitor photodetector 4 is in proportion to the intensity of the laser beam emitted from the laser diode 1, the magnitude of the drive current to be supplied to the laser diode 1 is controlled using a monitor signal obtained from the monitor photodetector 4, so that the intensity of the laser beam can be adjusted to desired intensity.

The laser beam reflected by the control film 3a passes through the quarter-wave plate 5 to be incident on the collimating lens 6, and is converted into a parallel beam by the collimating lens 6. The laser beam converted into the parallel beam by the collimating lens 6 is reflected by the reflection mirror 8, and then is incident on the objective lens 9. The laser beam incident on the objective lens 9 is applied as a focused spot to the signal recording layers of the optical disc D by the focusing operation of the objective lens 9.

When the laser beam focusing operation is performed by the objective lens 9, a spherical aberration is caused due to the difference in thickness of the protection layers lying between the signal recording layers and the surface, which is a signal incident surface of the optical disc D, however, adjustment can be made so as to minimize the spherical aberration by displacing the collimating lens 6 according to an embodiment of the present invention in the optical axis direction. Such an adjustment operation using the displacement of the collimating lens 6 is performed by driving to rotate the aberration correcting motor 7.

By the above described operations, the operation is performed of applying the laser beam to the signal recording layer included in the optical disc D. When such an applying operation is performed, the return beam reflected from the signal recording layer enters the objective lens 9 from the surface thereof facing the optical disc D. The return beam incident on the objective lens 9 enters the polarizing beam splitter 3 via the reflection mirror 8, the collimating lens 6, and the quarter-wave plate 5. Since the return beam incident on the polarizing beam splitter 3 has already been converted into the linearly polarized light beam in the P-direction, the return beam is allowed to pass through the control film 3a included in the polarizing beam splitter 3.

The return laser beam having passed through the control film 3a enters the sensor lens 10 as the control laser beam Lc, and an astigmatism is caused by the action of the sensor lens 10. The control laser beam Lc with the astigmatism caused by the sensor lens 10 is applied to a sensor portion of the quad sensor, etc., provided on the photodetector 11 by the focusing operation of the sensor lens 10. As a result of the return beam being applied to the photodetector 11 as such, the operation of generating a focus error signal is carried out as is well known, using a change in shape of a spot applied to the sensor portion included in the photodetector 11. The focusing control operation can be performed using such a focus error signal by displacing the objective lens 9 in a direction of the signal surface of the optical disc D.

Although not described in an embodiment of the present invention, the configuration is made such that a tracking control operation can be performed using the plus-first-order beam and the minus-first-order beam generated by the diffraction grating 2. The operation of reading signals recorded in the optical disc D is performed by performing such a control operation.

The quality of the focused spot formed on the signal recording layer of the optical disc D can be recognized by detecting the magnitude of the level of the reproduction signal obtained from the photodetector 11, and thus, the aberration correcting motor 7 is driven to rotate based on this recognition signal to adjust the position of the collimating lens 6 in the optical axis direction, thereby enabling the correction of the spherical aberration.

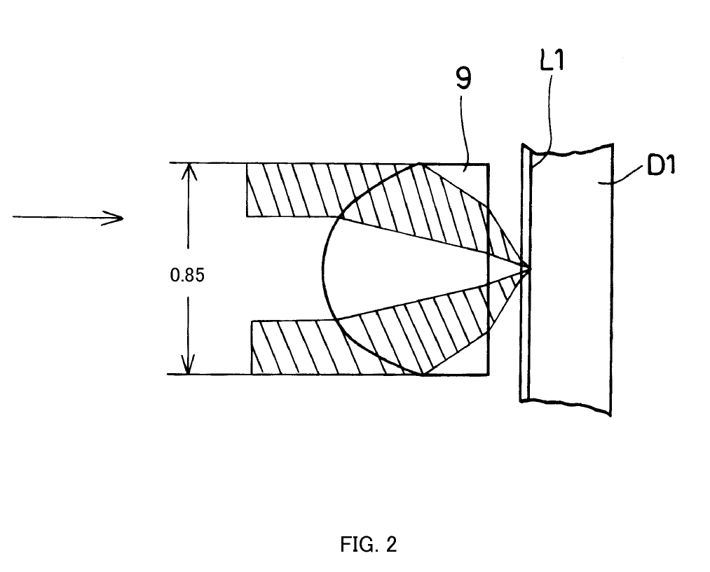

The signal reproduction operation, etc., in the optical pickup apparatus with the configuration shown in FIG. 1 is carried out as described above. The focusing operation of the objective lens 9 for the optical discs will then be described, which is the gist of an embodiment of the present invention, referring to FIGS. 2, 3 and 4.

In an embodiment of the present invention, description will be made assuming that the first optical disc D1 is a Blu-ray standard optical disc, the second optical disc D2 is a CD standard optical disc, and the third optical disc D3 is a DVD standard optical disc.

An annular diffraction zone (not shown) is formed on a surface of the objective lens 9 of an embodiment of the present invention on which the laser beam emitted from the laser diode 1 is incident. Such an annular diffraction zone is formed to have a sawtooth shape in cross section as described in Japanese Laid-Open Patent Publication No. 2006-107680, for example.

In such a configuration, the laser beam emitted from the laser diode 1 enters the objective lens 9, as a parallel beam, for example, in a direction indicated by an arrow as depicted in FIGS. 2, 3 and 4.

FIG. 2 depicts a relationship among the laser beam, the objective lens 9, and the first optical disc D1, in the case of using the first optical disc D1 that is a Blu-ray standard optical disc. An annular diffraction zone is formed on the surface of the objective lens 9 so that a shaded portion of the laser beam is focused on the signal recording layer L1 provided in the first optical disc D1.

The laser beam is focused on the signal recording layer L1 by the annular diffraction zone formed on the objective lens 9 in the case of using the first optical disc D1, and the configuration is made such that the laser beam, which is incident on a region on the outer circumference side of the objective lens 9, is used as depicted. When such a focusing operation is performed, the numerical aperture of the objective lens 9 is set at 0.85 as depicted, and the laser beam to be used by being diffracted by the annular diffraction zone is set to be a zero-order diffracted beam.

As described hereinabove, when using the first optical disc D1 that is a Blu-ray standard optical disc, the laser beam having a wavelength of 405 nm is used and the numerical aperture of the objective lens 9 is set at 0.85, so that it is possible to perform the operation of reading signals recorded on the signal recording layer L1 of the first optical disc D1.

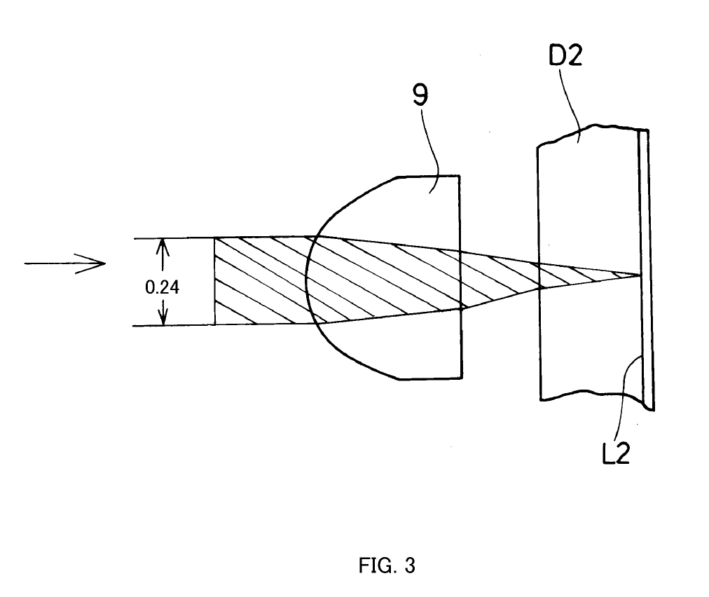

FIG. 3 depicts a relationship among the laser beam, the objective lens 9, and the second optical disc D2, in the case of using the second optical disc D2 that is a CD standard optical disc. An annular diffraction zone is formed on the surface of the objective lens 9 so that a shaded portion of the laser beam is focused on the signal recording layer L2 provided in the second optical disc D2.

The laser beam is focused on the signal recording layer L2 by the annular diffraction zone formed on the objective lens 9 in the case of using the second optical disc D2, and the configuration is made such that the laser beam, which is incident on a region on the inner circumference side of the objective lens 9, is used as depicted. When such a focusing operation is performed, the numerical aperture of the objective lens 9 is set at 0.24 as depicted, and the laser beam to be used by being diffracted by the annular diffraction zone is set to be a third-order diffracted beam.

The wavelength of the laser beam to be used to perform the operation of reading signals recorded in the CD standard optical disc is 785 nm as described above and the numerical aperture of the objective lens is set at 0.47, however, in an embodiment of the present invention, a laser beam having a shorter wavelength of 405 nm is employed as the laser beam and the numerical aperture of the objective lens 9 is reduced and set at 0.24, so that a focused spot can be formed that is similar to the focused spot required for reading signals recorded in the CD standard optical disc.

As described hereinabove, when using the second optical disc D2 that is a CD standard optical disc, the laser beam having a wavelength of 405 nm is used and the numerical aperture of the objective lens 9 is set at 0.24, so that a focused spot is formed that is similar to the focused spot required for reading signals recorded in the CD standard optical disc, and thus, it is possible to perform the operation of reading signals recorded on the signal recording layer L2 of the second optical disc D2 without any trouble.

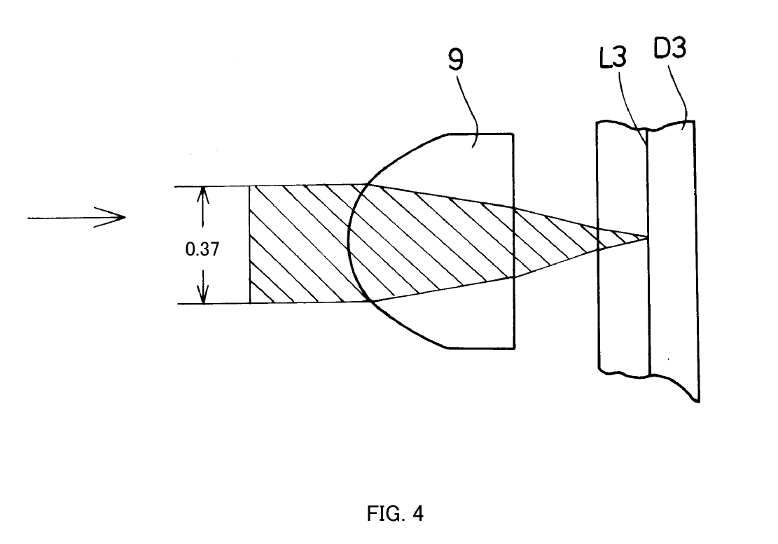

FIG. 4 depicts a relationship among the laser beam, the objective lens 9, and the third optical disc D3, in the case of using the third optical disc D3 that is a DVD standard optical disc. An annular diffraction zone is formed on the surface of the objective lens 9 so that a shaded portion of the laser beam is focused on the signal recording layer L3 provided in the third optical disc D3.

The laser beam is focused on the signal recording layer L3 by the annular diffraction zone formed on the objective lens 9 in the case of using the third optical disc D3, and the configuration is made such that the laser beam, which is incident on a region on the inner circumference side of the objective lens 9, is used as depicted. When such a focusing operation is performed, the numerical aperture of the objective lens 9 is set at 0.37 as depicted, and the laser beam to be used being diffracted by the annular diffraction zone is set to be a first-order diffracted beam.

The wavelength of the laser beam to be used to perform the operation of reading signals recorded in the DVD standard optical disc is 655 nm as described above and the numerical aperture of the objective lens is set at 0.6, however, in an embodiment of the present invention, a laser beam having a shorter wavelength of 405 nm is employed as the laser beam and the numerical aperture of the objective lens 9 is reduced and set at 0.37, so that a focused spot can be formed that is similar to the focused spot required for reading signals recorded in the DVD standard optical disc.

As described hereinabove, when using the third optical disc D3 that is a DVD standard optical disc, the laser beam having a wavelength of 405 nm is used and the numerical aperture of the objective lens 9 is set at 0.37, so that a focused spot is formed that is similar to the focused spot required for reading signals recorded in the DVD standard optical disc, and thus, it is possible to perform the operation of reading signals recorded on the signal recording layer L3 of the third optical disc D3 without any trouble.

As described above, it is possible to form focused spots suitable for performing the operations of reading the signals recorded in the second optical disc of CD standard and the third optical disc D3 of DVD standard, with the same objective lens 9. The configuration is made such that the laser beam to be used for the optical discs is focused by the region on the inner circumference side of the objective lens 9. That is, as apparent from FIGS. 3 and 4, the laser beam passing through the same region inside the region of the numerical aperture of 0.24.

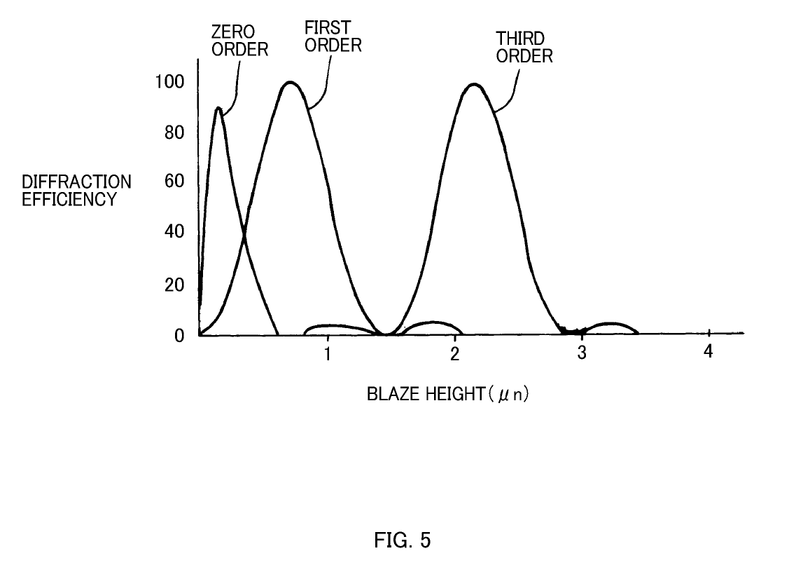

FIG. 5 depicts a relationship between the blaze height of the annular diffraction zone formed on the surface of the objective lens 9 and diffraction efficiency on an order-by-order basis of a diffracted beam. As is apparent from FIG. 5, setting can be made such that the first-order diffracted beam and the third-order diffracted beam do not interfere with each other. As such, the annular diffraction zone is formed on the surface of the objective lens 9 in which such a blaze height is set that allows the laser beam to be used to be split according to the order of the diffracted beam, and thus, it becomes possible to form both a focused spot suitable for performing the operation of reading signals recorded in the second optical disc D2 of CD standard and a focused spot suitable for performing the operation of reading signals recorded in the third optical disc D3 of DVD standard, using the same objective lens 9.

Although, in an embodiment of the present invention, the zero-order diffracted beam is used as the laser beam for performing the operation of reading signals recorded in the first optical disc D1, the third-order diffracted beam is used as the laser beam for performing the operation of reading signals recorded in the second optical disc D2, and the first-order diffracted beam is used as the laser beam for performing the operation of reading signals recorded in the third optical disc D3, the order of the diffracted beam to be used is not limitative, but can variously be changed.

A second embodiment of the present invention will hereinafter be described.

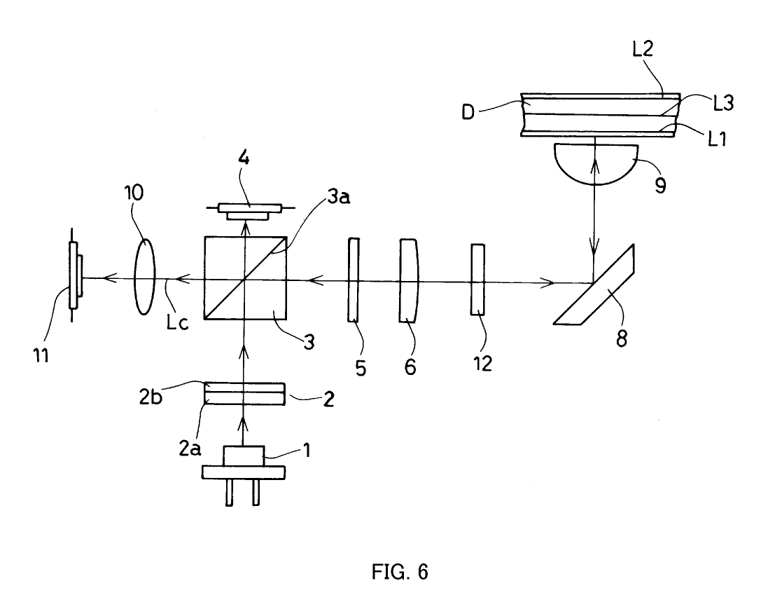

In a first embodiment of the present invention described above, the spherical aberration correcting operation is carried out by the operation of controlling the displacement of the collimating lens 6 in the optical axis direction, and a second embodiment of the present invention depicted in FIG. 6 will then be described.

In FIG. 6, the same constituent elements as those in a first embodiment of the present invention shown in FIG. 1 are designated by the same reference numerals, and the same operations thereof will be omitted.

Reference numeral 12 denotes a liquid crystal aberration correcting element on which the laser beam converted into a parallel beam by the collimating lens 6 is incident. The liquid crystal aberration correcting element 12 has a liquid crystal pattern for correcting at least a spherical aberration. Such a liquid crystal aberration correcting element 12 serves a function of correcting the spherical aberration by changing the refractive index, and includes glass substrates in pairs arranged facing each other, electrodes in pairs respectively having electrode patterns disposed respectively on the facing surfaces of the pair of glass substrates, and liquid crystal molecules aligned in such a manner as to be sandwiched between the facing electrodes via an alignment film.

The electrode patterns formed on the electrodes are in such a pattern as to correspond to the spherical aberration, and are shaped concentrically corresponding to the direction in which the spherical aberration is caused, for example. Alternatively, an electrode pattern for correcting the spherical aberration may be formed on one electrode, while an electrode pattern for correcting coma aberration may be formed on the other electrode. Such a configuration enables not only the spherical aberration but also the coma aberration to be corrected at the same time. Such a liquid crystal aberration correcting element 12 may variously be altered in configuration.

Such an aberration correcting operation by the liquid crystal aberration correcting element 12 is carried out by an operation of controlling the aberration correcting patterns provided on the liquid crystal aberration correcting element 12. Then, such a control operation for the aberration correction is performed so as to reduce the amount of spherical aberration detected from the reproduction signal generated by the photodetector 11.

As described above, in first and second embodiments of the present invention, an objective lens is provided that receives a laser beam emitted from the laser diode through an optical path consisting of the same optical elements, and that focuses the laser beam on the signal recording layer of the first optical disc having a short distance from the surface of the optical disc to the signal recording layer, on the signal recording layer of the second optical disc having a long distance from the surface of the optical disc to the signal recording layer, and on the signal recording layer of the third optical disc having a distance from the surface of the optical disc to the signal recording surface that is longer than that of the first optical disc and shorter than that of the second optical disc; and an annular diffraction zone, for generating a focused spot capable of performing the operation of reading signals recorded on the signal recording layers of the optical discs, is formed on the objective lens.

First and the second embodiments of the present invention are characterized in that the laser beam, which is focused by the region on the outer circumference side of the objective lens, is used to form a focused spot for performing the operation of reading the signals recorded on the signal recording layer included in the first optical disc, and that the laser beam, which is focused by the region on the inner circumference side of the objective lens, is used to form a focused spot for performing the operation of reading the signals recorded on the signal recording layers provided in the second and the third optical discs.

In first and second embodiments of the present invention, the diffracted beams diffracted by the annular diffraction zones are allowed to be different in optical order from one another, so that the focused spots for performing the operations of reading signals recorded on the signal recording layers are formed.

In first and second embodiments of the present invention, a spherical aberration correcting means for correcting the spherical aberration is provided on an optical path between the objective lens and the laser diode for emitting the laser beam.

In a first embodiment of the present invention, a collimating lens is used as the spherical aberration correcting means so that the spherical aberration is corrected by displacing the collimating lens in the optical axis direction.

In a second embodiment of the present invention, a liquid crystal aberration correcting element is used as the spherical aberration correcting means so that the spherical aberration is corrected by changing the patterns of the liquid crystal aberration correcting element.

The optical pickup apparatus according to first and second embodiments of the present invention allows the laser beam emitted from a single laser diode to enter a single objective lens through an optical path consisting of the same optical elements, and allows the beam to be focused on the signal recording layers provided in the optical discs of three different standards by an annular diffraction zone formed on the objective lens, thereby making it possible to reduce the number of optical elements. Accordingly, the optical pickup apparatus according to first and the second embodiments of the present invention is not only suitable for miniaturization, but also capable of being manufactured at a low cost.

In first and second embodiments of the present invention, the operations of reading signals recorded in a plurality of optical discs of different standards are performed, with the use of the laser beam having a short wavelength to be used for reading signals recorded in the Blu-ray standard optical disc, without the use of the laser beams to be used for reading signals recorded in the CD standard optical disc and the DVD standard optical disc, and thus, the embodiments can be applicable to other optical pickup apparatuses of different standards.

A third embodiment of the present invention will hereinafter be described.

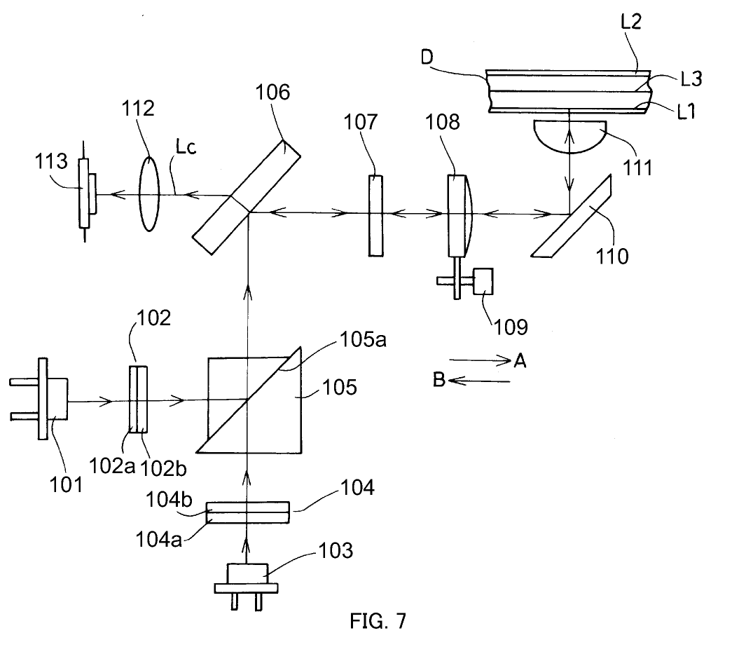

Referring to FIG. 7, reference numeral 101 denotes a first laser diode that emits a first laser beam which is a blue-violet beam having a wavelength of 405 nm, for example, and reference numeral 102 denotes a first diffraction grating on which the first laser beam emitted from the first laser diode 101 is incident. The first diffraction grating 102 includes a diffraction grating unit 102a that splits the laser beam into a main beam, which is a zero-order beam, and into two sub-beams, which are a plus-first-order beam and a minus-first-order beam, and a half-wave plate 102b that converts the incident laser beam into a linearly polarized light beam in the S-direction.

Reference numeral 103 denotes a second laser diode that emits a second laser beam which is an infrared beam having a wavelength of 785 nm, for example, and reference numeral 104 denotes a second diffraction grating on which the second laser beam emitted from the second laser diode 103 is incident. The second diffraction grating 104 includes a diffraction grating unit 104a that splits the laser beam into a main beam, which is a zero-order beam, and into two sub-beams, which are a plus-first-order beam and a minus-first-order beam, and a half-wave plate 104b that converts the incident laser beam into a linearly polarized light beam in the P-direction.

Reference numeral 105 denotes a polarizing beam splitter provided in a position where the first laser beam having passed through the first diffraction grating 102 and the second laser beam having passed through the second diffraction grating 104 are incident. The polarizing beam splitter 105 includes a control film 105a that reflects the laser beam converted into the laser beam, polarized in the S-direction by the half-wave plate 102b, and allows the laser beam, polarized in the P-direction by the half-wave plate 104b, to pass therethrough.

Reference numeral 106 denotes a half mirror that reflects the S-polarized light beam of the first laser beam reflected by the polarizing beam splitter 105 and allows the P-polarized light beam thereof to pass therethrough, and that reflects the P-polarized light beam of the second laser beam having passed through the polarizing beam splitter 105 and allows the S-polarized light beam thereof to pass therethrough.

Reference numeral 107 denotes a quarter-wave plate provided in a position where the laser beam reflected by the half mirror 106 is incident. The quarter-wave plate 107 serves a function of converting the incident laser beam from a linearly polarized light beam into a circularly polarized light beam, or from a circularly polarized light beam into a linearly polarized light beam. Reference numeral 108 denotes a collimating lens on which the laser beam having passed through the quarter-wave plate 107 is incident and which converts the incident laser beam into a parallel beam. The collimating lens 108 is configured so as to be displaced by an aberration correcting motor 109 in the optical axis direction, i.e. in directions indicated by arrows A and B. The configuration is made such that the spherical aberration caused due to the thickness of the protection layer of the optical disc D is corrected by the displacement operation of the collimating lens 108 in the optical axis direction.

Reference numeral 110 denotes a raising mirror (reflection mirror) provided in a position where the laser beam having passed through the collimating lens 108 is incident. The raising mirror 8 is configured to reflect the incident laser beam in a direction of an objective lens 111.

D denotes an optical disc. D1 denotes the signal recording layer included in the first optical disc D1 having a shorter distance from the surface of the optical disc to the signal recording layer; L2 denotes the signal recording layer included in the second optical disc D2 having a longer distance from the surface of the optical disc to the signal recording layer; and L3 denotes the signal recording layer included in the third optical disc D3 having a distance from the surface of the optical disc to the signal recording layer which is longer than that in the first optical disc D1 and shorter than that in the second optical disc D2.

In such a configuration, the first laser beam emitted from the first laser diode 101 is incident on the objective lens 111 via the diffraction grating 102, the polarizing beam splitter 105, the half mirror 106, the quarter-wave plate 107, the collimating lens 108, and the raising mirror 110, and thereafter, the first laser beam is applied as a focused spot to the signal recording layer L1 included in the first optical disc D1 or to the signal recording layer L3 included in the optical disc D3 by the focusing operation of the objective lens 111. The first laser beam applied to the signal recording layer L1 or L3 is reflected as a return beam by the signal recording layer L1 or L3.

The second laser beam emitted from the second laser diode 103 is incident on the objective lens 111 via the diffraction grating 104, the polarizing beam splitter 105, the half mirror 106, the quarter-wave plate 107, the collimating lens 108, and the raising mirror 110, and thereafter, the second laser beam is applied as a focused spot to the signal recording layer L2 included in the second optical disc D2 by the focusing operation of the objective lens 111. The second laser beam applied to the signal recording layer L2 is reflected as a return beam by the signal recording layer L2.

The return beam reflected from the signal recording layer L1, L2, or L3 of the optical disc D is incident on the half mirror 106 via the objective lens 111, the raising mirror 110, the collimating lens 108, and the quarter-wave plate 107. In the return beam incident on the half mirror 106 as such, the first laser beam is converted into a linearly polarized light beam in the P-direction and the second laser beam is converted into a linearly polarized light beam in the S-direction by the phase shift operation by the quarter-wave plate 107. Accordingly, such return beams of the first laser beam and the second laser beam are allowed to pass through the half mirror 106 as control laser beams Lc without being reflected by the half mirror 106.

Reference numeral 112 denotes a sensor lens on which the control laser beam Lc having passed through the half mirror 106 is incident. The sensor lens 106 serves a function of applying the control laser beam Lc, with astigmatism added thereto, to a light receiving portion provided in the photodetector 113 which is called PDIC. The photodetector 113 is provided with a known quad sensor, etc., and is configured to perform, by a main beam application operation, a signal generating operation associated with an operation of reading signals recorded on the signal recording layer of the optical disc D and a focus error signal generating operation for executing a focusing control operation by an astigmatism method, and to perform, by two-sub-beam applying operations, a tracking error signal generating operation for the executing a tracking control operation.

The optical pickup apparatus according to an embodiment of the present invention is configured as described above. In such a configuration, the objective lens 111 is fixed to a lens holding frame (not shown) that is supported on a base of the optical pickup apparatus by four or six supporting wires in such a manner as to be capable of a displacement operation in a direction perpendicular to a signal surface of the optical disc D, i.e., in a focusing direction and a displacement operation in a radial direction of the optical disc D, i.e., in a tracking direction.

The above described displacement operations of the objective lens 111 in the focusing direction and the tracking direction are carried out by supplying a drive signal to a focusing coil and a tracking coil provided on the lens holding frame.

The optical pickup apparatus according to an embodiment of the present invention is configured as described above, and an operation of the optical pickup apparatus with such a configuration will be described for each optical disc.

When performing the operation of reproducing signals recorded in the first optical disc D1, a drive current is supplied to the first laser diode 101, and the first laser diode 101 emits a first laser beam having a wavelength of 405 nm. The first laser beam emitted from the first laser diode 101 enters the first diffraction grating 102, to be split by the diffraction grating unit 102a making up the first diffraction grating 102 into a zero-order beam, a plus-first-order beam, and a minus-first-order beam, and to be converted by the half-wave plate 102b into a linearly polarized light beam in the S-direction. The first laser beam having passed through the first diffraction grating 102 enters the polarizing beam splitter 105, and is reflected by the control film 105a included in the polarizing beam splitter 105.

The first laser beam reflected by the control film 105a enters the half mirror 106. Since such a laser beam is an S-polarized light beam, it is reflected by the half mirror 106 in a direction of the quarter-wave plate 107. The first laser beam incident on the quarter-wave plate 107 is converted into a circularly polarized light beam, and thereafter enters the collimating lens 108 to be converted into a parallel beam by the collimating lens 108. The laser beam converted into the parallel beam by the collimating lens 108 is reflected by the reflection mirror 110, and then enters the objective lens 111. The laser beam incident on the objective lens 111 is applied as a focused spot to the signal recording layer L1 of the first optical disc D1 by the focusing operation of the objective lens 111.

When the first laser beam focusing operation is performed by the objective lens 111, a spherical aberration is caused due to the thickness of the protection layer lying between the signal recording layer L1 and the surface, which is a signal incident surface of the optical disc, however, adjustment can be made so as to minimize the spherical aberration by displacing the collimating lens 108 according to an embodiment of the present invention in the optical axis direction. Such an adjustment operation using the displacement of the collimating lens 108 is performed by driving to rotate the aberration correcting motor 109.

By the above described operations, the operation is performed of applying the first laser beam to the signal recording layer L1 included in the first optical disc D1. When such an applying operation is performed, the return beam reflected from the signal recording layer L1 enters the objective lens 111 from the surface thereof facing the first optical disc D1. The return beam incident on the objective lens 111 enters the half mirror 106 via the reflection mirror 110, the collimating lens 108, and the quarter-wave plate 107. Since the return beam incident on the half mirror 106 has already been converted into the linearly polarized light beam in the P-direction by the quarter-wave plate 107, the return beam is allowed to pass through the half mirror 106.

The return laser beam having passed through the half mirror 106 enters the sensor lens 112 as the control laser beam Lc, and an astigmatism is caused by the action of the sensor lens 112. The control laser beam Lc with the astigmatism caused by the sensor lens 112 is applied to the sensor portion of the quad sensor, etc., provided on the photodetector 113 by the focusing operation of the sensor lens 112. As a result of the return beam being applied to the photodetector 113 as such, the operation of generating a focus error signal is carried out as is well known, using a change in shape of a spot applied to the sensor portion included in the photodetector 113. The focusing control operation can be performed using such a focus error signal by displacing the objective lens 111 in a direction of the signal surface of the first optical disc D1.

Although not described in an embodiment of the present invention, the configuration is made such that a well-known tracking control operation can be performed using the plus-first-order beam and the minus-first-order beam generated by the first diffraction grating 102. The operation of reading signals recorded in the first optical disc D1 is performed by performing such a control operation.

The quality of the focused spot formed on the signal recording layer L1 of the first optical disc D1 can be recognized by detecting the magnitude of the level of the reproduction signal obtained from the photodetector 113, and thus, the aberration correcting motor 109 is driven to rotate based on this recognition signal to adjust the position of the collimating lens 108 in the optical axis direction, thereby enabling the correction of the spherical aberration.

The operation of reproducing signals recorded in the first optical disc D1 by the optical pickup apparatus is carried out as described above. An operation of reproducing signals recorded in the second optical disc D2 will then be described.

When performing the operation of reproducing signals recorded in the second optical disc D2, a drive current is supplied to the second laser diode 103, and the second laser diode 103 emits a second laser beam having a wavelength of 785 nm. The second laser beam emitted from the second laser diode 103 enters the second diffraction grating 104, to be split by the diffraction grating unit 104a making up the second diffraction grating 104 into a zero-order beam, a plus-first-order beam, and a minus-first-order beam, and to be converted by the half-wave plate 104b into a linearly polarized light beam in the P-direction. The second laser beam having passed through the second diffraction grating 104 enters the polarizing beam splitter 105, to pass through the control film 105a included in the polarizing beam splitter 105.

The second laser beam having passed through the control film 105a enters the half mirror 106. Since such a laser beam is a P-polarized light beam, it is reflected by the half mirror 106 in a direction of the quarter-wave plate 107. The second laser beam incident on the quarter-wave plate 107 is converted into a circularly polarized light beam, and thereafter enters the collimating lens 108 to be converted into a parallel beam by the action of the collimating lens 108. The laser beam converted into the parallel beam by the collimating lens 108 is reflected by the reflection mirror 110, and then enters the objective lens 111. The laser beam incident on the objective lens 111 is applied as a focused spot to the signal recording layer L2 of the second optical disc D2 by the focusing operation of the objective lens 111.

When the second laser beam focusing operation is performed by the objective lens 111, a spherical aberration is caused due to the thickness of the protection layer lying between the signal recording layer L1 and the surface, which is a signal incident surface of the optical disc, however, in such case as well, adjustment can be made so as to minimize the spherical aberration by displacing the collimating lens 108 according to an embodiment of the present invention in the optical axis direction. Such an adjustment operation using the displacement of the collimating lens 108 is performed by driving to rotate the aberration correcting motor 109.

By the above described operations, the operation is performed of applying the second laser beam to the signal recording layer L2 included in the second optical disc D2. When such an applying operation is performed, the return beam reflected from the signal recording layer L2 enters the objective lens 111 from the surface thereof facing the second optical disc D2. The return beam incident on the objective lens 111 enters the half mirror 106 via the reflection mirror 110, the collimating lens 108, and the quarter-wave plate 107. Since the return beam incident on the half mirror 106 has already been converted into the linearly polarized light beam in the S-direction by the quarter-wave plate 107, the return beam is allowed to pass through the half mirror 106.

The return laser beam having passed through the half mirror 106 enters the sensor lens 112 as the control laser beam Lc, and an astigmatism is caused by the action of the sensor lens 112. The control laser beam Lc with the astigmatism caused by the sensor lens 112 is applied to the sensor portion of the quad sensor, etc., provided on the photodetector 113 by the focusing operation of the sensor lens 112. As a result of the return beam being applied to the photodetector 113 as such, the operation of generating a focus error signal is carried out as is well known, using a change in shape of a spot applied to the sensor portion included in the photodetector 113. The focusing control operation can be performed using such a focus error signal by displacing the objective lens 111 in a direction of the signal surface of the second optical disc D2.

Although not described in an embodiment of the present invention, the configuration is made such that a well-known tracking control operation can be performed using the plus-first-order beam and the minus-first-order beam generated by the second diffraction grating 104. The operation of reading signals recorded in the second optical disc D2 is performed by performing such a control operation.

The quality of the focused spot formed on the signal recording layer L2 of the second optical disc D2 can be recognized by detecting the magnitude of the level of the reproduction signal obtained from the photodetector 113, and thus, the aberration correcting motor 109 is driven to rotate based on this recognition signal to adjust the position of the collimating lens 108 in the optical axis direction, thereby enabling the correction of the spherical aberration.

The operations of reproducing signals recorded in the first optical disc D1 and the second optical disc D2 are carried out as described above. An operation of reproducing signals recorded in the third optical disc D3 will then be described.

Such an operation of reproducing signals recorded in the third optical disc D3 is carried out using an optical system to be used to perform the operation of reading signals recorded in the first optical disc D1.

That is, in such a case, a drive current is supplied to the first laser diode 101 so that the first laser diode 101 emits a first laser beam having a wavelength of 405 nm. Such a first laser beam enters the objective lens 111 via the first diffraction grating 102, the polarizing beam splitter 105, the half mirror 106, the quarter-wave plate 107, the collimating lens 108, and the reflection mirror 110, as described above, and a focused spot is formed on the signal recording layer L3 included in the third optical disc D3 by the focusing operation of the objective lens 111.

The return beam reflected by the signal recording layer L3 is applied to the photodetector 113 via the objective lens 111, the reflection mirror 110, the collimating lens 108, the quarter-wave plate 107, the half mirror 106, and the sensor lens 112.

The operation of reproducing signals recorded in the third optical disc D3 can be performed through the execution of the focusing control operation, the tracking control operation, and the aberration correction operation based on the above operations.

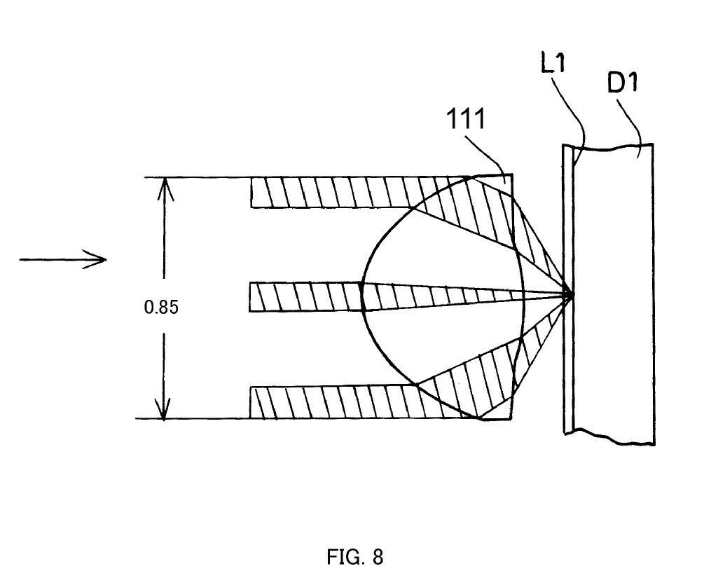

The signal reproduction operation, etc., of the optical pickup apparatus with the configuration shown in FIG. 7 is carried out as described above. The focusing operation of the objective lens 111 for the optical discs will then be described, which is the gist of an embodiment of the present invention, referring to FIGS. 8, 9 and 10.

In an embodiment of the present invention, description will be made assuming that the first optical disc D1 is a Blu-ray standard optical disc, the second optical disc D2 is a CD standard optical disc, and the third optical disc D3 is a DVD standard optical disc.

An annular diffraction zone (not shown) is formed on a surface of the objective lens 111 of an embodiment of the present invention on which the laser beams are incident that are emitted from the first laser diode 101 and from the second laser diode 103. Such an annular diffraction zone is formed to have a sawtooth shape in cross section as described in Japanese Laid-Open Patent Publication No. 2006-107680, for example.

In such a configuration, the first laser beam and the second laser beam respectively emitted from the first laser diode 101 and the second laser diode 103 enter the objective lens 111, as parallel beams, for example, in a direction indicated by an arrow as depicted in FIGS. 8, 9 and 10.

FIG. 8 depicts a relationship among the first laser beam, the objective lens 111, and the first optical disc D1, in the case of using the first optical disc D1 that is a Blu-ray standard optical disc. An annular diffraction zone is formed on the surface of the objective lens 111 so that a shaded portion of the first laser beam emitted from the first laser diode 101 is focused on the signal recording layer L1 provided in the first optical disc D1.

In the case of using the first optical disc D1, the laser beam is focused on the signal recording layer L1 by the annular diffraction zone formed on the objective lens 111, and the configuration is made such that the laser beam, which is incident on a region on the outer circumference side of the objective lens 111, and the laser beam, which is incident on a central region of the objective lens 111, are used as depicted. When such a focusing operation is performed, the numerical aperture of the objective lens 111 is set at 0.85 as depicted, and the laser beam to be used by being diffracted by the annular diffraction zone is set to be a zero-order diffracted beam.

As described hereinabove, when using the first optical disc D1 that is a Blu-ray standard optical disc, the first laser beam having a wavelength of 405 nm, which is emitted from the first laser diode 101, is used and the numerical aperture of the objective lens 111 is set at 0.85, so that it is possible to precisely perform the operation of reading signals recorded on the signal recording layer L1 of the first optical disc D1.

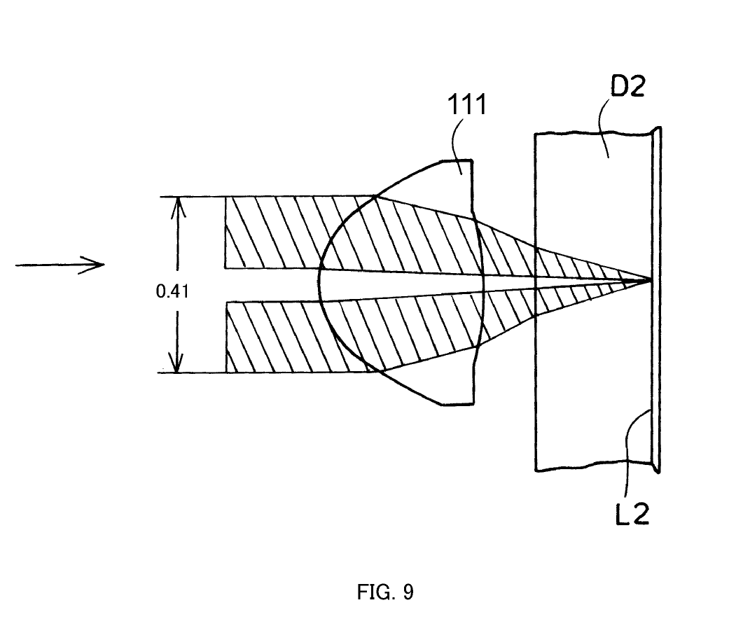

FIG. 9 depicts a relationship among the second laser beam, the objective lens 111, and the second optical disc D2, in the case of using the second optical disc D2 that is a CD standard optical disc. An annular diffraction zone is formed on the surface of the objective lens 111 so that a shaded portion of the second laser beam emitted from the second laser diode 103 is focused on the signal recording layer L2 provided in the second optical disc D2.

In the case of using the second optical disc D, the laser beam is focused on the signal recording layer L2 by the annular diffraction zone formed on the objective lens 1112, the configuration is made such that the laser beam, which incident on a region on the inner circumference side excluding the central region in the objective lens 111, is used as depicted. When such a focusing operation is performed, the numerical aperture of the objective lens 111 is set at 0.41 as depicted, and the laser beam to be used by being diffracted by the annular diffraction zone is set to be a first-order diffracted beam.

The wavelength of the laser beam to be used to perform the operation of reading signals recorded in the CD standard optical disc is 785 nm as described above and the numerical aperture of the objective lens is set at 0.47, however, in an embodiment of the present invention, a laser beam having a wavelength of 785 nm is employed as the laser beam and the numerical aperture of the objective lens 111 is reduced and set at 0.41, so that a focused spot can be formed that is similar to the focused spot required for reading signals recorded in the CD standard optical disc.

As described hereinabove, when using the second optical disc D2 that is a CD standard optical disc, the second laser beam having a wavelength of 785 nm is used and the numerical aperture of the objective lens 111 is set at 0.41, so that a focused spot is formed that is similar to the focused spot required for reading signals recorded in the CD standard optical disc, and thus, it is possible to perform the operation of reading signals recorded on the signal recording layer L2 of the second optical disc D2 without any trouble.

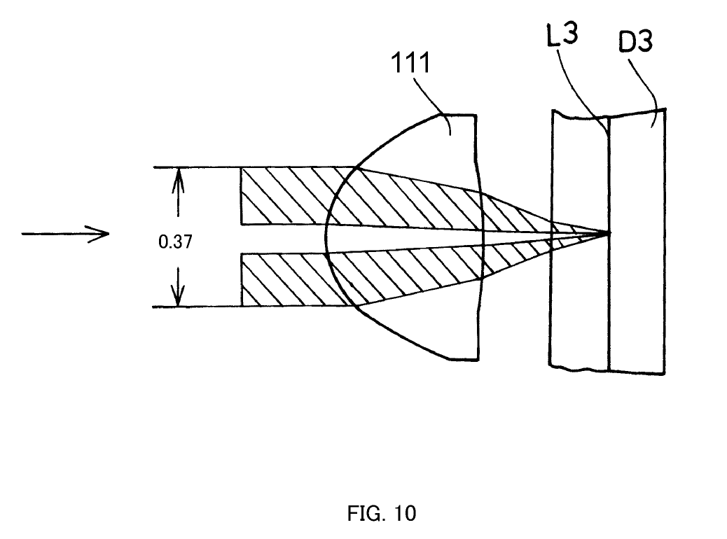

FIG. 10 depicts a relationship among the laser beam, the objective lens 111, and the third optical disc D3, in the case of using the third optical disc D3 that is a DVD standard optical disc. An annular diffraction zone is formed on the surface of the objective lens 111 so that a shaded portion of the laser beam is focused on the signal recording layer L3 provided in the third optical disc D3.

In the case of using the third optical disc D3, the laser beam is focused on the signal recording layer L3 by the annular diffraction zone formed on the objective lens 111, and the configuration is made such that the laser beam, which is incident on a region on the inner circumference side excluding the central region in the objective lens 111, is used as depicted. When such a focusing operation is performed, the numerical aperture of the objective lens 111 is set at 0.37 as depicted and the laser beam to be used by being diffracted by the annular diffraction zone is set to be a third-order diffracted beam.

The wavelength of the laser beam to be used to perform the operation of reading signals recorded in the DVD standard optical disc is 655 nm as described above and the numerical aperture of the objective lens is set at 0.6, however, in an embodiment of the present invention, a laser beam having a shorter wavelength of 405 nm is employed as the laser beam and the numerical aperture of the objective lens 111 is reduced and set at 0.37 so that a focused spot can be formed that is similar to the focused spot required for reading signals recorded in the DVD standard optical disc.

As described hereinabove, when using the third optical disc D3 that is a DVD standard optical disc, the laser beam having a wavelength of 405 nm is used and the numerical aperture of the objective lens 111 is set at 0.37, so that a focused spot is formed that is similar to the focused spot required for reading signals recorded in the DVD standard optical disc, and thus, it is possible to perform the operation of reading signals recorded on the signal recording layer L3 of the third optical disc D3 without any trouble.

As described above, it is possible to form focused spots suitable for the operations of reading signals recorded in the first optical disc D1 of Blu-ray standard and the third optical disc D3 of DVD standard, using the same objective lens 111 and the first laser beam having a wavelength of 405 nm emitted from the same laser diode, i.e., the first laser diode 101. The configuration is made such that the laser beam obtained from the region on the outer circumference side and the central region of the objective lens 111 or the laser beam obtained from the region on the inner circumference side exclusive of the central region thereof is focused on the signal recording layer included in the optical discs.

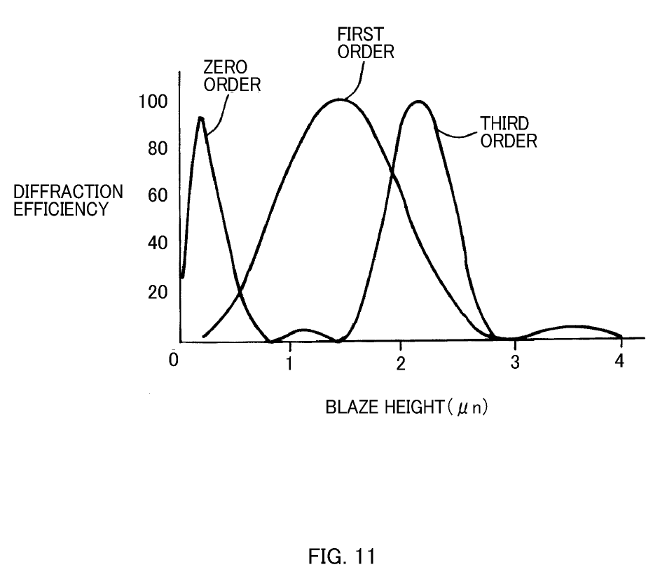

FIG. 11 depicts a relationship between the blaze height of the annular diffraction zone formed on the surface of the objective lens 111 and the diffraction efficiency on an order-by-order basis of a diffracted beam. As is apparent from FIG. 11, setting can be made such that the zero-order diffracted beam and the third-order diffracted beam of the first laser beam having a wavelength of 405 nm do not interfere with each other. As such, the annular diffraction zone is formed on the surface of the objective lens 111 in which such a blaze height is set that allows the laser beam to be used to be split according to the order of the diffracted beam, and thus, it becomes possible to form a focused spot, using the same objective lens 111, which is suitable for the operation of reading signals recorded in the third optical disc D3 of DVD standard with a laser beam having a wavelength suitable for the operation of reading signals recorded in the first optical disc D1 of Blu-ray standard.

The first-order diffracted beam depicted in FIG. 11 is indicative of the characteristics of the second laser beam having a wavelength of 785 nm emitted from the second laser diode 103 to be used in the signal reading operation of the second optical disc D2 of CD standard. The blaze height is selected to be able to form a focused spot suitable for the operation of reading signals recorded on the signal recording layer included in the second optical disc D2.

Although, in an embodiment of the present invention, the zero-order diffracted beam is used as the laser beam for performing the operation of reading signals recorded in the first optical disc D1, the first-order diffracted beam is used as the laser beam for performing the operation of reading signals recorded in the second optical disc D2, and the third-order diffracted beam is used as the laser beam for performing the operation of reading signals recorded in the third optical disc D3, the order of the diffracted beam to be used is not limitative, but can variously be changed.

In an embodiment of the present invention, the operation of reading signals recorded on the signal recording layer L1 of the first optical disc D1 is carried out by the first laser beam obtained from the region on the outer circumference side and the central region in the objective lens 111; the operation of reading signals recorded on the signal recording layer L2 of the second optical disc D2 is carried out by the second laser beam obtained from the region on the inner circumference side exclusive of the central region in the objective lens 111; and the operation of reading signals recorded on the signal recording layer L3 of the third optical disc D3 is carried out by the first laser beam obtained from the region on the inner circumference side exclusive of the central region in the objective lens 111. However, the region to be used can variously be altered without any trouble as long as it is a region capable of obtaining the quantity of light required for the signal reading operation.

Further, in an embodiment of the present invention, two laser diodes, are used i.e., the first laser diode 101 for emitting the first laser beam and the second laser diode 103 for emitting the second laser beam, however, such a laser diode may naturally be employed that is called a two-wavelength laser with a single common housing in which a plurality of laser diodes are included as described in Japanese Laid-Open Patent Publication No. 2007-179636.

The quarter-wave plate 107 provided for converting from a linearly polarized light beam into a circularly polarized light beam and vice versa in an embodiment of the present invention is configured so as to have a structure suitable for the wavelength of the laser diode to be used.

A fourth embodiment of the present invention will hereinafter be described.

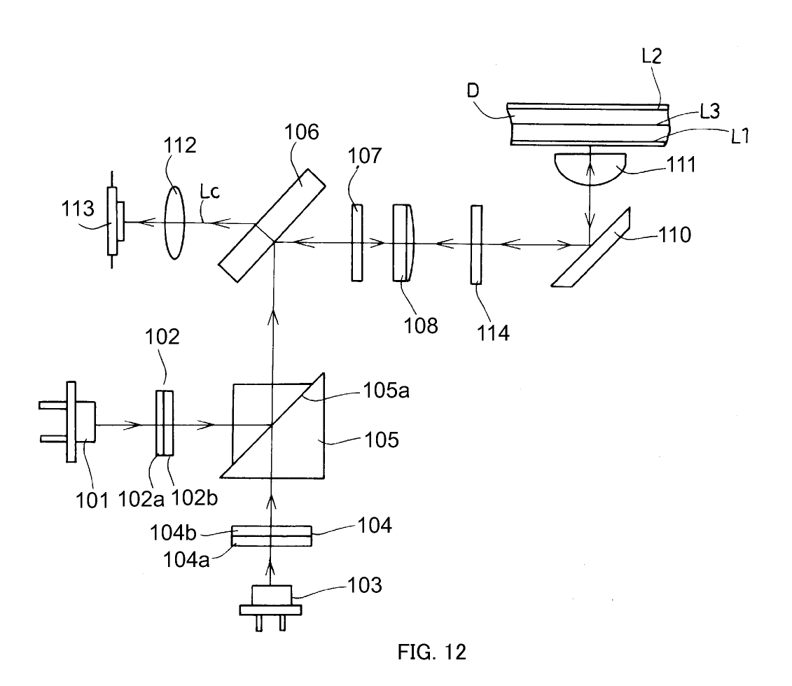

In a third embodiment of the present invention described above, the spherical aberration correcting operation is carried out by the operation of controlling the displacement of the collimating lens 108 in the optical axis direction, and, a fourth embodiment of the present invention depicted in FIG. 12 will then be described.

In FIG. 12, the same constituent elements as those in a third embodiment of the present invention shown in FIG. 7 are designated by the same reference numerals, and the same operations thereof will be omitted.

Reference numeral 114 denotes a liquid crystal aberration correcting element on which the laser beam converted into a parallel beam by the collimating lens 108 is incident. The liquid crystal aberration correcting element 114 has a liquid crystal pattern for correcting at least a spherical aberration. Such a liquid crystal aberration correcting element 114 serves a function of correcting the spherical aberration by changing the refractive index, as is known and includes glass substrates in pairs arranged facing each other, electrodes in pairs respectively having electrode patterns disposed respectively on the facing surfaces of the pair of glass substrates, and liquid crystal molecules aligned in such a manner as to be sandwiched between the facing electrodes via an orientation film.

The electrode patterns formed on the electrodes are in such a pattern as to correspond to the spherical aberration and are shaped concentrically corresponding to the direction in which the spherical aberration is caused, for example. Alternatively, an electrode pattern for correcting the spherical aberration may be formed on one electrode, while an electrode pattern for correcting coma aberration may be formed on the other electrode. Such a configuration enables not only the spherical aberration but also the coma aberration to be corrected at the same time. Such a liquid crystal aberration correcting element 114 may variously be altered in configuration.

Such an aberration correcting operation by the liquid crystal aberration correcting element 114 is carried out by an operation of controlling the aberration correcting patterns provided on the liquid crystal aberration correcting element 114 as is known. Then, such a control operation for the aberration correction is performed so as to reduce the amount of spherical aberration detected from the reproduction signal generated by the photodetector 113.

As described above, third and fourth embodiments of the present invention includes: an objective lens that focuses the laser beam on the signal recording layer of the first optical disc having a short distance from the surface of the optical disc to the signal recording layer, on the signal recording layer of the second optical disc having a long distance from the surface of the optical disc to the signal recording layer, and on the signal recording layer of the third optical disc having a distance from the surface of the optical disc to the signal recording surface that is longer than that of the first optical disc and shorter than that of the second optical disc; a first laser diode that generates a first laser beam having a wavelength suitable for performing the operation of reading signals recorded on the signal recording layer of the first optical disc; and a second laser diode that generates a second laser beam having a wavelength longer than that of the first laser beam and suitable for performing the operation of reading signals recorded on the signal recording layer of the second optical disc, wherein the objective lens is formed with an annular diffraction zone configured to focus the first laser beam emitted from the first laser diode on the signal recording layer included in the first optical disc and on the signal recording layer included in the third optical disc to form a focused spot, and formed with an annular diffraction zone configured to focus the second laser beam emitted from the second laser diode on the signal recording layer included in the second optical disc to form a focused spot.

In third and fourth embodiments of the present invention, the diffracted beams diffracted by the annular diffraction zones are allowed to be different in optical order from one another, so that the focused spots, for performing the operations of reading signals recorded on the signal recording layers included in the optical discs, are formed.

In third and fourth embodiments of the present invention, a spherical aberration correcting means for correcting the spherical aberration is provided on an optical path between the objective lens and the first laser diode for emitting the first laser beam and on an optical path between the objective lens and the second laser diode for emitting the second laser beam.

In a third embodiment of the present invention, a collimating lens is used as the spherical aberration correcting means so that the spherical aberration is corrected by displacing the collimating lens in the optical axis direction.

In a fourth embodiment of the present invention, a liquid crystal aberration correcting element is used as the spherical aberration correcting means so that the spherical aberration is corrected by changing the patterns of the liquid crystal aberration correcting element.

The optical pickup apparatus according to third and fourth embodiments of the present invention is configured such that the laser beams emitted from two different laser diodes are allowed to enter a single objective lens to be focused on the signal recording layers of the optical discs of three different standards by the action of the annular diffraction zone formed on the objective lens, namely, such that the operations of reading signals recorded on the signal recording layers of the optical discs of different standards are carried out by a single objective lens, thereby making it possible to reduce the number of optical elements.

Since provided are the first laser diode for generating the first laser beam having a wavelength suitable for the operation of reading signals recorded in the first optical disc having a short distance from the surface thereof to the signal recording layer and the second laser diode for generating the second laser beam having a wavelength suitable for the operation of reading signals recorded in the second optical disc having a long distance from the surface thereof to the signal recording layer, accurate operations are ensured of reading signals recorded in the first optical disc and the second optical disc.

Thus, in the case of using a CD standard optical disc as the second optical disc, it is possible to form a focused spot adapted for different types of optical discs such as a CD-ROM, a CD-R, and a CD-RW.

In third and fourth embodiments of the present invention, the operations of reading signals recorded in a plurality of optical discs of different standards are performed, with the use of the laser beam having a short wavelength to be used for reading signals recorded in the Blu-ray standard optical disc, without the use of the laser beam to be used for reading signals recorded in the DVD standard optical disc, and thus, the embodiments can be applicable to other optical pickup apparatuses of different standards.

A fifth embodiment of the present invention will hereinafter be described.

The same constituent elements as those in a third embodiment of the present invention shown in FIG. 7 are designated by the same reference numerals, and the same operations thereof will be omitted.

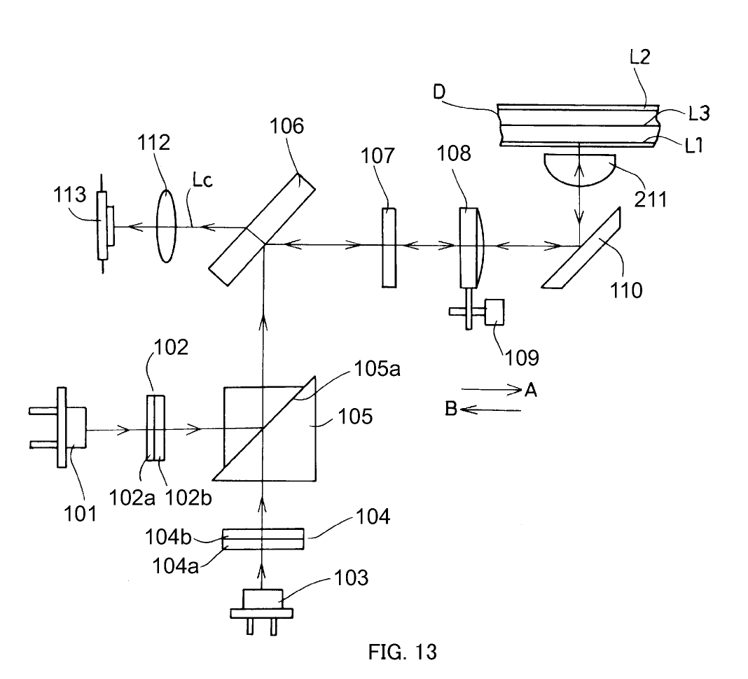

In FIG. 13, the first laser beam emitted from the first laser diode 101 is incident on an objective lens 211 via the diffraction grating 102, the polarizing beam splitter 105, the half mirror 106, the quarter-wave plate 107, the collimating lens 108, and the raising mirror 110, and thereafter, the first laser beam is applied as a focused spot to the signal recording layer L1 included in the first optical disc D1 by the focusing operation of the objective lens 211. The first laser beam applied to the signal recording layer L1 is reflected as a return beam by the signal recording layer L1.

The second laser beam emitted from the second laser diode 103 is incident on the objective lens 211 via the diffraction grating 104, the polarizing beam splitter 105, the half mirror 106, the quarter-wave plate 107, the collimating lens 108, and the raising mirror 110, and thereafter, the second laser beam is applied as a focused spot to the signal recording layer L2 included in the second optical disc D2 or to the signal recording layer L3 included in the third optical disc D3 by the focusing operation of the objective lens 211. The second laser beam applied to the signal recording layer L2 or L3 is reflected as a return beam by the signal recording layer L2 or L3.

Such an operation of reproducing signals recorded in the third optical disc D3 is carried out using an optical system to be used to perform the operation of reading signals recorded in the second optical disc D2.

That is, in such a case, a drive current is supplied to the second laser diode 103 so that the second laser diode 103 emits a second laser beam having a wavelength of 785 nm. Such a second laser beam enters the objective lens 211 via through the second diffraction grating 104, the polarizing beam splitter 105, the half mirror 106, the quarter-wave plate 107, the collimating lens 108, and the reflection mirror 110, as described above, and a focused spot is formed on the signal recording layer L3 included in the third optical disc D3 by the focusing operation of the objective lens 211.

The return beam reflected by the signal recording layer L3 is applied to the photodetector 113 via the objective lens 211, the reflection mirror 110, the collimating lens 108, the quarter-wave plate 107, the half mirror 106, and the sensor lens 112.

The operation of reproducing signals recorded in the third optical disc D3 can be performed through the execution of the focusing control operation, the tracking control operation, and the aberration correction operation based on the above operations.

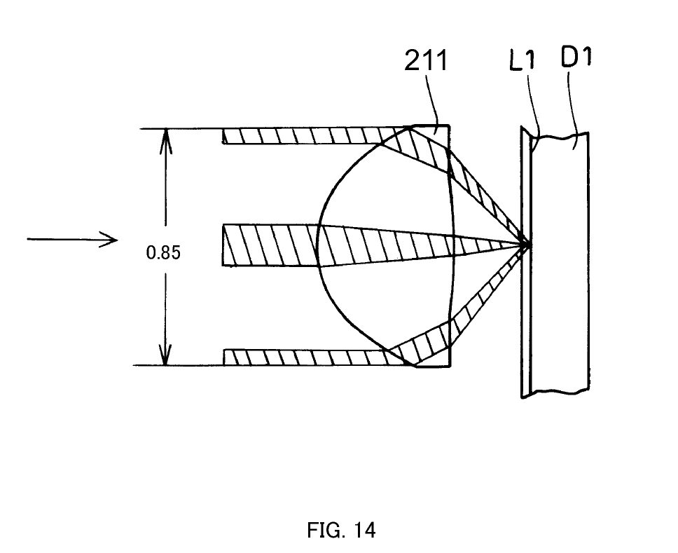

The focusing operation of the objective lens 211 for the optical discs will then be described, which is the gist of an embodiment of the present invention, referring to FIGS. 14, 15 and 16.

In an embodiment of the present invention, description will be made assuming that the first optical disc D1 is a Blu-ray standard optical disc, the second optical disc D2 is a CD standard optical disc, and the third optical disc D3 is a DVD standard optical disc.

An annular diffraction zone (not shown) is formed on a surface of the objective lens 211 of an embodiment of the present invention on which the laser beams are incident that are emitted from the first laser diode 101 and from the second laser diode 103. Such an annular diffraction zone is formed to have a sawtooth shape in cross section as described in Japanese Laid-Open Patent Publication No. 2006-107680, for example.

In such a configuration, the first laser beam and the second laser beam respectively emitted from the first laser diode 101 and the second laser diode 103 enter the objective lens 211, as parallel beams, for example, in a direction indicated by an arrow as depicted in FIGS. 14, 15 and 16.

FIG. 14 depicts a relationship among the first laser beam, the objective lens 211, and the first optical disc D1, in the case of using the first optical disc D1 that is a Blu-ray standard optical disc. An annular diffraction zone is formed on the surface of the objective lens 211 so that a shaded portion of the first laser beam emitted from the first laser diode 101 is focused on the signal recording layer L1 provided in the first optical disc D1.

In the case of using the first optical disc D1, the laser beam is focused on the signal recording layer L1 by the annular diffraction zone formed on the objective lens 211, and the configuration is made such that the laser beam, which is incident on a region on the outer circumference side of the objective lens 211, and the laser beam, which is incident on a central region of the objective lens 211, are used as depicted. When such a focusing operation is performed, the numerical aperture of the objective lens 211 is set at 0.85 as depicted, and the laser beam to be used by being diffracted by the annular diffraction zone is set to be a first-order diffracted beam.

As described hereinabove, when using the first optical disc D1 that is a Blu-ray standard optical disc, the first laser beam having a wavelength of 405 nm, which is emitted from the first laser diode 101, is used and the numerical aperture of the objective lens 211 is set at 0.85, so that it is possible to precisely perform the operation of reading signals recorded on the signal recording layer L1 of the first optical disc D1.

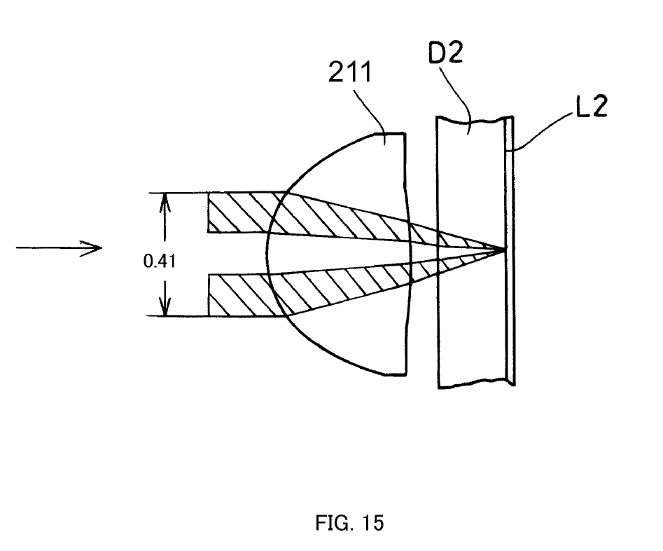

FIG. 15 depicts a relationship among the second laser beam, the objective lens 211, and the second optical disc D2, in the case of using the second optical disc D2 that is a CD standard optical disc. An annular diffraction zone is formed on the surface of the objective lens 211 so that a shaded portion of the second laser beam emitted from the second laser diode 103 is focused on the signal recording layer L2 provided in the second optical disc D2.

In the case of using the second optical disc D, the laser beam is focused on the signal recording layer L2 by the annular diffraction zone formed on the objective lens 211, the configuration is made such that the laser beam, which incident on a region on the inner circumference side excluding the central region in the objective lens 211, is used as depicted. When such a focusing operation is performed, the numerical aperture of the objective lens 211 is set at 0.41 as depicted, and the laser beam to be used by being diffracted by the annular diffraction zone is set to be a first-order diffracted beam.

The wavelength of the laser beam to be used to perform the operation of reading signals recorded in the CD standard optical disc is 785 nm as described above and the numerical aperture of the objective lens is set at 0.47, however, in an embodiment of the present invention, a laser beam having a wavelength of 785 nm is employed as the laser beam and the numerical aperture of the objective lens 211 is reduced and set at 0.41, so that a focused spot can be formed that is similar to the focused spot required for reading signals recorded in the CD standard optical disc.

As described hereinabove, when using the second optical disc D2 that is a CD standard optical disc, the second laser beam having a wavelength of 785 nm is used and the numerical aperture of the objective lens 211 is set at 0.41, so that a focused spot is formed that is similar to the focused spot required for reading signals recorded in the CD standard optical disc, and thus, it is possible to perform the operation of reading signals recorded on the signal recording layer L2 of the second optical disc D2 without any trouble.

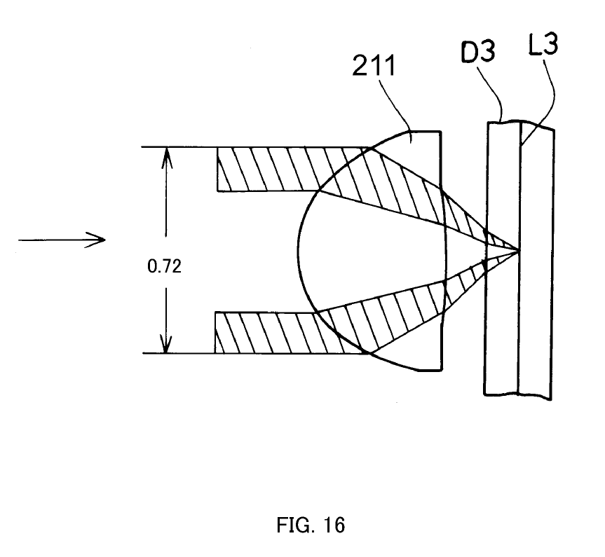

FIG. 16 depicts a relationship among the second laser beam, the objective lens 211, and the third optical disc D3, in the case of using the third optical disc D3 that is a DVD standard optical disc. An annular diffraction zone is formed on the surface of the objective lens 211 so that a shaded portion of the laser beam is focused on the signal recording layer L3 provided in the third optical disc D3.

In the case of using the third optical disc D3, the laser beam is focused on the signal recording layer L3 by the annular diffraction zone formed on the objective lens 211, and the configuration is made such that the laser beam, which is incident on a region on the outer circumference side excluding the central region in the objective lens 211, i.e., a region thereof that is used for a reading operation for the second optical disc D2, is used as depicted. When such a focusing operation is performed, the numerical aperture of the objective lens 211 is set at 0.72 as depicted and the laser beam to be used by being diffracted by the annular diffraction zone is set to be a first-order diffracted beam.

The wavelength of the laser beam to be used to perform the operation of reading signals recorded in the DVD standard optical disc is 655 nm as described above and the numerical aperture of the objective lens is set at 0.6, however, in an embodiment of the present invention, a laser beam having a longer wavelength of 785 nm is employed as the laser beam and the numerical aperture of the objective lens 211 is increased and set at 0.72 so that a focused spot can be formed that is similar to the focused spot required for reading signals recorded in the DVD standard optical disc.

As described hereinabove, when using the third optical disc D3 that is a DVD standard optical disc, the laser beam having a wavelength of 785 nm is used and the numerical aperture of the objective lens 211 is set at 0.72, so that a focused spot is formed that is similar to the focused spot required for reading signals recorded in the DVD standard optical disc, and thus, it is possible to perform the operation of reading signals recorded on the signal recording layer L3 of the third optical disc D3 without any trouble.

As described above, it is possible to form focused spots suitable for the operations of reading signals recorded in the second optical disc D2 of CD standard and the third optical disc D3 of DVD standard, using the same objective lens 211 and the second laser beam having a wavelength of 785 nm emitted from the same laser diode, i.e., the second laser diode 103. The configuration is made such that the second laser beam obtained from the region on the inner circumference side exclusive of the central region of the objective lens 211 and the second laser beam obtained from the region on the outer circumference side, in which the numerical aperture is large, exclusive of the central region is focused on the signal recording layer included in the optical discs.

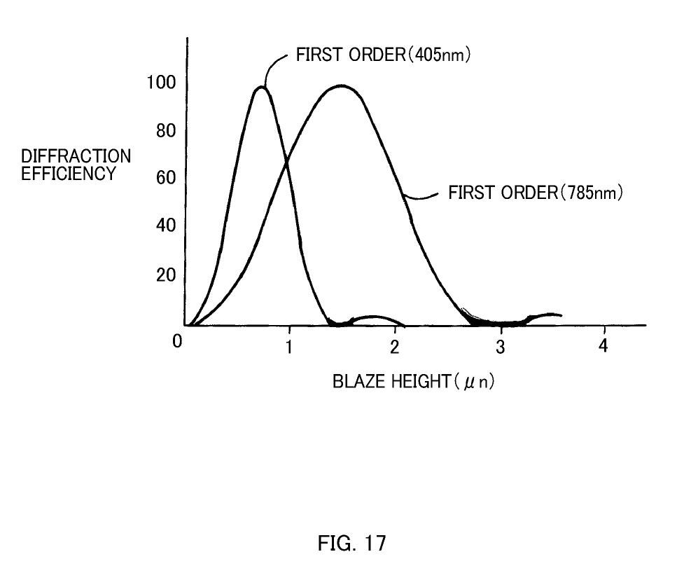

FIG. 17 depicts a relationship between the blaze height of the annular diffraction zone formed on the surface of the objective lens 211 and the diffraction efficiency on an order-by-order basis of a diffracted beam. As is apparent from FIG. 17, setting can be made such that the first-order diffracted beam of the first laser beam having a wavelength of 405 nm and the first-order diffracted beam of the second laser beam having a wavelength of 785 nm do not interfere with each other. As such, the annular diffraction zone is formed on the surface of the objective lens 211 in which such the blaze height is set that allows the first laser beam and the second laser beam to be used to be split according to the order of the diffracted beam, and thus, it becomes possible to form focused spots, using the same objective lens 211, which are a focused spot suitable for the operation of reading signals recorded in the first optical disc D1 of Blu-ray standard, a focused spot suitable for the operation of reading signals recorded in the second optical disc D2 of CD standard, and a focused spot suitable for the operation of reading signals recorded in the third optical disc D3 of DVD standard.

The operation of reading signals recorded on the signal recording layers of the second optical disc D2 of CD standard and of the third optical disc D3 of DVD standard is carried out by using the first-order diffracted beam of the second laser beam emitted from the same laser diode, i.e., by using the same diffracted beam, and thus, the structure of the annular diffraction zone formed on the objective lens 211 can be simplified as compared with the case of using diffracted beams of different orders.

Although, in an embodiment of the present invention, the zero-order diffracted beam is used as the laser beam for performing the operation of reading signals recorded in the first optical disc D1, and the first-order diffracted beam is used as the laser beam for performing the operation of reading signals recorded in the second optical disc D2 and the third optical disc D3, the order of the diffracted beam to be used is not limitative, but can variously be changed.

In an embodiment of the present invention, the operation of reading signals recorded on the signal recording layer L1 of the first optical disc D1 is carried out by the first laser beam obtained from the region on the outer circumference side and the central region in the objective lens 211; the operation of reading signals recorded on the signal recording layer L2 of the second optical disc D2 is carried out by the second laser beam obtained from the region on the inner circumference side exclusive of the central region in the objective lens 211; and the operation of reading signals recorded on the signal recording layer L3 of the third optical disc D3 is carried out by the second laser beam obtained from the region on the outer circumference side exclusive of the central region in the objective lens 211. However, the region to be used can variously be altered without any trouble as long as it is a region capable of obtaining the quantity of light required for the signal reading operation.

Further, in an embodiment of the present invention, two laser diodes, are used i.e., the first laser diode 101 for emitting the first laser beam and the second laser diode 103 for emitting the second laser beam, however, such a laser diode may naturally be employed that is called a two-wavelength laser with a single common housing in which a plurality of laser diodes are included as described in Japanese Laid-Open Patent Publication No. 2007-179636.

The quarter-wave plate 107 provided for converting from a linearly polarized light beam into a circularly polarized light beam and vice versa in an embodiment of the present invention is configured so as to have a structure suitable for the wavelength of the laser diode to be used.

A sixth embodiment of the present invention will hereinafter be described.

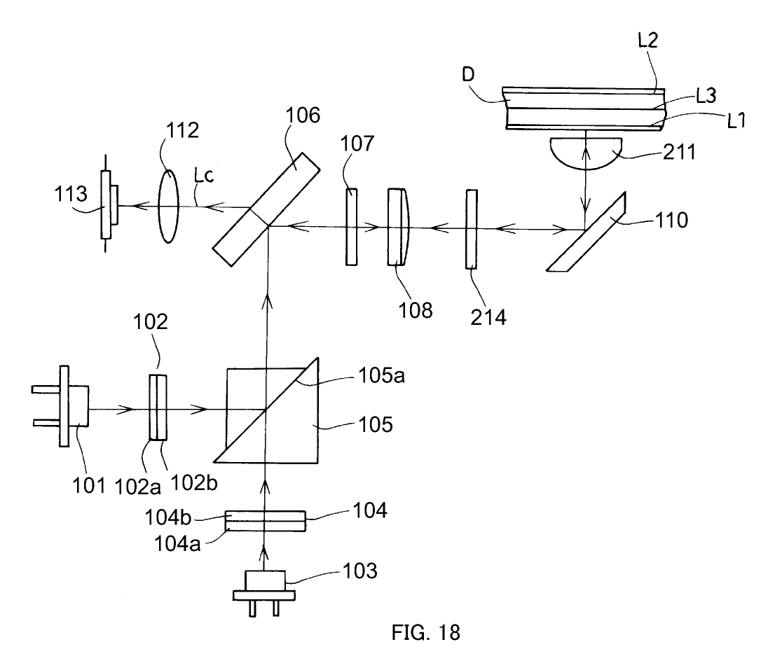

In a fifth embodiment of the present invention described above, the spherical aberration correcting operation is carried out by the operation of controlling the displacement of the collimating lens 108 in the optical axis direction, and, a sixth embodiment of the present invention depicted in FIG. 18 will then be described.

In FIG. 13, the same constituent elements as those in a fifth embodiment of the present invention shown in FIG. 7 are designated by the same reference numerals, and the same operations thereof will be omitted.

Reference numeral 214 denotes a liquid crystal aberration correcting element on which the laser beam converted into a parallel beam by the collimating lens 108 is incident. The liquid crystal aberration correcting element 214 has a liquid crystal pattern for correcting at least a spherical aberration. Such a liquid crystal aberration correcting element 214 serves a function of correcting the spherical aberration by changing the refractive index, as is known and includes glass substrates in pairs arranged facing each other, electrodes in pairs respectively having electrode patterns disposed respectively on the facing surfaces of the pair of glass substrates, and liquid crystal molecules aligned in such a manner as to be sandwiched between the facing electrodes via an orientation film.

The electrode patterns formed on the electrodes are in such a pattern as to correspond to the spherical aberration and are shaped concentrically corresponding to the direction in which the spherical aberration is caused, for example. Alternatively, an electrode pattern for correcting the spherical aberration may be formed on one electrode, while an electrode pattern for correcting coma aberration may be formed on the other electrode. Such a configuration enables not only the spherical aberration but also the coma aberration to be corrected at the same time. Such a liquid crystal aberration correcting element 214 may variously be altered in configuration.

Such an aberration correcting operation by the liquid crystal aberration correcting element 214 is carried out by an operation of controlling the aberration correcting patterns provided on the liquid crystal aberration correcting element 214 as is known. Then, such a control operation for the aberration correction is performed so as to reduce the amount of spherical aberration detected from the reproduction signal generated by the photodetector 113.

As described above, the optical pickup apparatus according to fifth and the sixth embodiments of the present invention includes: an objective lens that focuses the laser beam on the signal recording layer of the first optical disc having a short distance from the surface thereof to the signal recording layer, on the signal recording layer of the second optical disc having a long distance from the surface thereof to the signal recording layer, and on the signal recording layer of the third optical disc having a distance from the surface thereof to the signal recording surface that is longer than that of the first optical disc and shorter than that of the second optical disc; a first laser diode that generates a first laser beam having a wavelength suitable for performing the operation of reading signals recorded on the signal recording layer of the first optical disc; and a second laser diode that generates a second laser beam having a wavelength longer than that of the first laser beam and suitable for performing the operation of reading signals recorded on the signal recording layer of the second optical disc, wherein the objective lens is formed with an annular diffraction zone configured to focus the first laser beam emitted from the first laser diode on the signal recording layer included in the first optical disc to form a focused spot, and formed with an annular diffraction zone configured to focus the second laser beam emitted from the second laser diode on the signal recording layers provided in the second optical disc and in the third optical disc to form a focused spot.

In fifth and sixth embodiments of the present invention, a spherical aberration correcting means for correcting the spherical aberration is provided on an optical path between the objective lens and the first laser diode for emitting the first laser beam and on an optical path between the objective lens and the second laser diode emitting the second laser beam.

In a fifth embodiment of the present invention, a collimating lens is used as the spherical aberration correcting means so that the spherical aberration is corrected by displacing the collimating lens in the optical axis direction.

In a sixth embodiment of the present invention, a liquid crystal aberration correcting element is used as the spherical aberration correcting means so that the spherical aberration is corrected by changing the patterns of the liquid crystal aberration correcting element.

The optical pickup apparatus according to fifth and sixth embodiments of the present invention is configured such that the laser beams emitted from two different laser diodes are allowed to enter a single objective lens to be focused on the signal recording layers of the optical discs of three different standards by the action of the annular diffraction zone formed on the objective lens, namely, such that the operations of reading signals recorded on the signal recording layers of the optical discs of different standards are carried out by a single objective lens, thereby making it possible to reduce the number of optical elements.

Since provided are the first laser diode for generating the first laser beam having a wavelength suitable for the operation of reading signals recorded in the first optical disc having a short distance from the surface thereof to the signal recording layer and the second laser diode for generating the second laser beam having a wavelength suitable for the operation of reading signals recorded in the second optical disc having a long distance from the surface thereof to the signal recording layer, accurate operations are ensured of reading signals recorded in the first optical disc and the second optical disc.

Thus, in the case of using a CD standard optical disc as the second optical disc, it is thus possible to form a focused spot adapted for different types of optical discs such as a CD-ROM, a CD-R, and a CD-RW.

In fifth and sixth embodiments of the present invention, the operation of reading signals recorded in a plurality of optical discs of different standards are performed, with the use of the laser beam having a long wavelength to be used for reading signals recorded in the CD standard optical disc, without the use of the laser beam to be used for reading signals recorded in the DVD standard optical disc, and thus, the embodiments can be applicable to other optical pickup apparatuses of different standards.

The wavelength of 405 nm of the laser beam indicates a typical wavelength of a laser beam having blue-violet wavelength which is suitable for the Blu-ray standard optical disc, and the laser beam having a wavelength of 405 nm in an embodiment of the present invention is not limited to the laser beam having this wavelength, but may appropriately be changed within a blue-violet wavelength range of the laser beam which is suitable for the Blu-ray standard optical disc. The wavelength of 785 nm of the laser beam indicates a typical wavelength of a laser beam having infrared wavelength which is suitable for the CD standard optical disc, and the laser beam having a wavelength of 785 nm in an embodiment of the present invention is not limited to the laser beam having this wavelength, but may appropriately be changed within an infrared wavelength range of the laser beam which is suitable for the CD standard optical disc.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a laser diode configured to generate a laser beam; and
an objective lens having an annular diffraction zone formed on an incident surface thereof on which the laser beam is incident, the annular diffraction zone being a zone configured to focus the laser beam on each of signal recording layers of first to third optical discs so that a signal recorded in each of the signal recording layers of the first to third optical discs are read, the first optical disc having the signal recording layer at a first distance from a surface thereof, the second optical disc having the signal recording layer at a second distance longer than the first distance from a surface thereof, the third optical disc having the signal recording layer at a third distance longer than the first distance and shorter than the second distance from a surface thereof.

2. The optical pickup apparatus of claim 1, wherein
the objective lens includes:
a first annular diffraction zone configured to diffract the laser beam incident on a first region on an outer circumference side of the incident surface so as to focus the laser beam on the signal recording layer of the first optical disc;
a second annular diffraction zone configured to diffract the laser beam incident on a second region on an inner circumference side of the incident surface so as to focus the laser beam on the signal recording layer of the second optical disc; and
a third annular diffraction zone configured to diffract the laser beam incident on a third region on an inner circumference side of the incident surface so as to focus the laser beam on the signal recording layer of the third optical disc.

3. The optical pickup apparatus of claim 2, wherein
diffracted beams, diffracted by the first to third annular diffraction zones, are of optical orders different from one another.

4. The optical pickup apparatus of claim 1, wherein
the laser beam has a first wavelength for reading a signal recorded on the signal recording layer of the first optical disc.

5. The optical pickup apparatus of claim 1, comprising:
a spherical aberration correcting element disposed on an optical path between the laser diode and the objective lens, the spherical aberration correcting element configured to correct a spherical aberration.

6. The optical pickup apparatus of claim 5, wherein
the spherical aberration correcting element includes:
a collimating lens; and
a member configured to displace the collimating lens in a direction of an optical axis of the laser beam to correct the spherical aberration.

7. The optical pickup apparatus of claim 5, wherein
the spherical aberration correcting element includes a liquid crystal aberration correcting element whose liquid crystal pattern is so changed as to correct the spherical aberration.

8. The optical pickup apparatus of claim 1, wherein
the laser diode includes:
a first laser diode configured to generate a first laser beam having a first wavelength for reading a signal recorded on the signal recording layer of the first optical disc; and
a second laser diode configured to generate a second laser beam having a second wavelength, which is longer than the first wavelength, for reading a signal recorded on the signal recording layer of the second optical disc, and wherein
the objective lens includes:
a first annular diffraction zone configured to focus the first laser beam on the signal recording layer of the first optical disc;
a second annular diffraction zone configured to focus the second laser beam on the signal recording layer of the second optical disc; and
a third annular diffraction zone configured to focus the first laser beam on the signal recording layer of the third optical disc;

9. The optical pickup apparatus of claim 8, wherein
diffracted beams, diffracted by the first to third annular diffraction zones, are of optical orders different from one another.

10. The optical pickup apparatus of claim 8, comprising:
a spherical aberration correcting element disposed on an optical path common to an optical path between the first laser diode and the objective lens and to an optical path between the second laser diode and the objective lens, the spherical aberration correcting element configured to correct a spherical aberration.

11. The optical pickup apparatus of claim 10, wherein
the spherical aberration correcting element includes:
a collimating lens; and
a member configured to displace the collimating lens in a direction of the same optical axis of the first laser beam and the second laser beam to correct the spherical aberration.

12. The optical pickup apparatus of claim 10, wherein
the spherical aberration correcting element includes a liquid crystal aberration correcting element whose liquid crystal pattern is so changed as to correct the spherical aberration.

13. The optical pickup apparatus of claim 1, wherein
the laser diode includes:
a first laser diode configured to generate a first laser beam having a first wavelength for reading a signal recorded on the signal recording layer of the first optical disc; and
a second laser diode configured to generate a second laser beam having a second wavelength, which is longer than the first wavelength, for reading a signal recorded on the signal recording layer of the second optical disc, and wherein
the objective lens includes:
a first annular diffraction zone configured to focus the first laser beam on the signal recording layer of the first optical disc;
a second annular diffraction zone configured to focus the second laser beam on the signal recording layer of the second optical disc; and
a third annular diffraction zone configured to focus the second laser beam on the signal recording layer of the third optical disc;

14. The optical pickup apparatus of claim 13, comprising:
a spherical aberration correcting element disposed on an optical path common to an optical path between the first laser diode and the objective lens and to an optical path between the second laser diode and the objective lens, the spherical aberration correcting element configured to correct a spherical aberration.

15. The optical pickup apparatus of claim 14, wherein
the spherical aberration correcting element includes:
a collimating lens; and
a member configured to displace the collimating lens in a direction of the same optical axis of the first laser beam and the second laser beam to correct the spherical aberration.

16. The optical pickup apparatus of claim 14, wherein
the spherical aberration correcting element includes a liquid crystal aberration correcting element whose liquid crystal pattern is so changed as to correct the spherical aberration.
